(19) United States
(12) Patent Application Publication
(10) Pub. No.: US 2025/0298827 A1
(43) Pub. Date: Sep. 25, 2025

(54) METHOD, APPARATUS, DEVICE AND MEDIUM FOR BOOK SEARCH

(71) Applicant: Beijing Zitiao Network Technology Co., Ltd., Beijing (CN)

(72) Inventors: Jinghua Li, Beijing (CN); Guibo Pan, Beijing (CN); Yiyong Li, Beijing (CN); Dongling Gao, Beijing (CN); Xingwen Zhang, Beijing (CN); Yifan Zhu, Beijing (CN)

(21) Appl. No.: 18/968,884

(22) Filed: Dec. 4, 2024

(30) Foreign Application Priority Data
Mar. 25, 2024 (CN) 202410346393.5

(51) Int. Cl. G06F 16/335; G06F 16/334

(52) U.S. Cl. CPC G06F 16/335; G06F 16/3344

(57) ABSTRACT

According to embodiments of the disclosure, a method, an apparatus, a device and a medium for book search are provided. The method includes: acquiring query information of a user; determining a book search intent of the user at least based on the query information; determining at least one book matching the book search intent; determining recommendation information for recommending the at least one book to the user at least based on the book search intent; and providing a response to the query information to the user, the response including an indication of the at least one book and the recommendation information. Thereby, it is possible to quickly and accurately meet a user's personalized book search needs, and providing the recommendation information that better matches the intent can improve user satisfaction and conversion rate of book recommendation.

### CROSS REFERENCE

The application claims priority to Chinese Patent Application No. 202410346393.5, filed on Mar. 25, 2024, and entitled “METHOD, APPARATUS, DEVICE AND MEDIUM FOR BOOK SEARCH”, the entirety of which is incorporated herein by reference.

### FIELD

Example implementations of the present disclosure generally relate to the field of computer, and in particular to a method, an apparatus, a device and a computer-readable storage medium for book search.

### BACKGROUND

With the development of computer technologies, online reading has gradually become the mainstream trend of users' reading. For online reading, in the scenario where users search for books, it is difficult for a system to determine the real needs expressed by a user since each user has a different intent of searching for a book, thus reducing the accuracy of the book recommendation from the system to the user. Therefore, it is expected that the system can accurately recommend books that meet the real needs of the users.

### SUMMARY

In a first aspect of the present disclosure, there is provided a method for book search. In this method, query information of a user is acquired; a book search intent of the user is determined at least based on the query information; at least one book matching the book search intent is determined; recommendation information for recommending the at least one book to the user is determined at least based on the book search intent; and a response to the query information is provided to the user, the response including an indication of the at least one book and the recommendation information.

In a second aspect of the present disclosure, there is provided an apparatus for book search. The apparatus includes: an information acquiring module configured to acquire query information of a user; an intent determining module configured to determine a book search intent of the user at least based on the query information; a book determining module configured to determine at least one book matching the book search intent; an information determining module configured to determine recommendation information for recommending the at least one book to the user at least based on the book search intent; and a response providing module configured to provide a response to the query information to the user, the response including an indication of the at least one book and the recommendation information.

In a third aspect of the present disclosure, there is provided an electronic device. The electronic device includes: at least one processing unit; and at least one memory coupled to the at least one processing unit and storing instructions executable by the at least one processing unit, the instructions, when executed by the at least one processing unit, causing the electronic device to perform the method according to the first aspect of the present disclosure.

In a fourth aspect of the present disclosure, there is provided a computer-readable storage medium having a computer program stored thereon, the computer program, when executed by a processor, causing the processor to implement the method according to the first aspect of the present disclosure.

In a fifth aspect of the present disclosure, there is provided a computer program product. The computer program product is tangibly stored in a computer storage medium and includes computer-executable instructions, the computer-executable instructions, when executed by a device, causing the device to perform the method of the first aspect.

It should be understood that the content described in this summary section is not intended to define the key features or important features of the implementations of the present disclosure, nor to limit the scope of the present disclosure. Other features of the present disclosure will become easily understood through the following description.

### BRIEF DESCRIPTION OF THE DRAWINGS

In the following, the above and other features, advantages and aspects of various implementations of the present disclosure will become more apparent with reference to the drawings and in conjunction with the following detailed description. In the drawings, the same or similar reference symbols refer to the same or similar elements, where:

FIG. 1 illustrates a schematic diagram of an example environment in which embodiments of the present disclosure can be implemented;

FIG. 2 illustrates a flowchart of a process for book search according to some embodiments of the present disclosure;

FIG. 3A illustrates a schematic diagram of an example interface for book search according to some embodiments of the present disclosure;

FIG. 3B to FIG. 3C illustrate schematic diagrams of example interfaces for acquiring query information of a user according to some embodiments of the present disclosure;

FIG. 3D illustrates a schematic diagram of an example interface for acquiring query information of a user according to other embodiments of the present disclosure;

FIG. 4 illustrates a block diagram of an apparatus for book search according to some embodiments of the present disclosure; and

FIG. 5 illustrates a block diagram of a device capable of implementing multiple implementations of the present disclosure.

### DETAILED DESCRIPTION

Implementations of the present disclosure will be described in more detail below with reference to the drawings. Although some embodiments of the present disclosure are shown in the drawings, it should be understood that the present disclosure may be implemented in various forms and should not be construed as limited to the implementations set forth herein. Rather, these embodiments are provided for a more thorough and complete understanding of the present disclosure. It should be understood that the drawings and implementations of the present disclosure are only for illustrative purposes, and are not intended to limit the protection scope of the present disclosure.

In the description of the implementations of the present disclosure, the term “comprise/include” and similar terms should be understood as open inclusion, that is, “comprise/include but not limited to”. The term “based on” should be understood as “at least partially based on”. The term “one implementation” or “the implementation” should be understood as “at least one implementation”. The term “some embodiments” should be understood as “at least some embodiments”. Other explicit and implicit definitions may also be included below. As used herein, the term “model” may represent an association relationship between various data. For example, the above association relationship may be acquired based on various technical solutions currently known and/or to be developed in the future.

It can be understood that the data involved in this technical solution (including but not limited to the data itself, the acquisition or use of the data) should comply with the requirements of corresponding laws, regulations and related provisions.

It can be understood that before using the technical solutions disclosed in various embodiments of the present disclosure, the user should be informed of the type, scope of use, use scenario, etc. of the personal information involved in the present disclosure in an appropriate manner in accordance with relevant laws and regulations, and the user's authorization should be obtained.

For example, in response to receiving an active request from a user, prompt information is sent to the user, so as to explicitly prompt the user that the operation requested to be performed by him/her will require the acquisition and use of the user's personal information. Thereby, the user can independently choose whether to provide the personal information to the software or hardware such as the electronic device, the application, the server, or the storage medium that performs the operations of the technical solutions of the present disclosure according to the prompt information.

As an optional but non-limiting implementation, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide the personal information to the electronic device.

It can be understood that the above process of notifying and acquiring the user's authorization is only illustrative, and does not constitute a limitation on the implementations of the present disclosure. Other methods that meet relevant laws and regulations may also be applied to the implementations of the present disclosure.

The term “in response to” used herein means a state in which a corresponding event occurs or a condition is satisfied. It will be understood that the execution timing of a subsequent action performed in response to the event or condition is not necessarily strongly correlated with the time when the event occurs or the condition is established. For example, in some cases, the subsequent action may be performed immediately when the event occurs or the condition is established; while in other cases, the subsequent action may be performed after a period of time after the event occurs or the condition is established.

### Example Environment

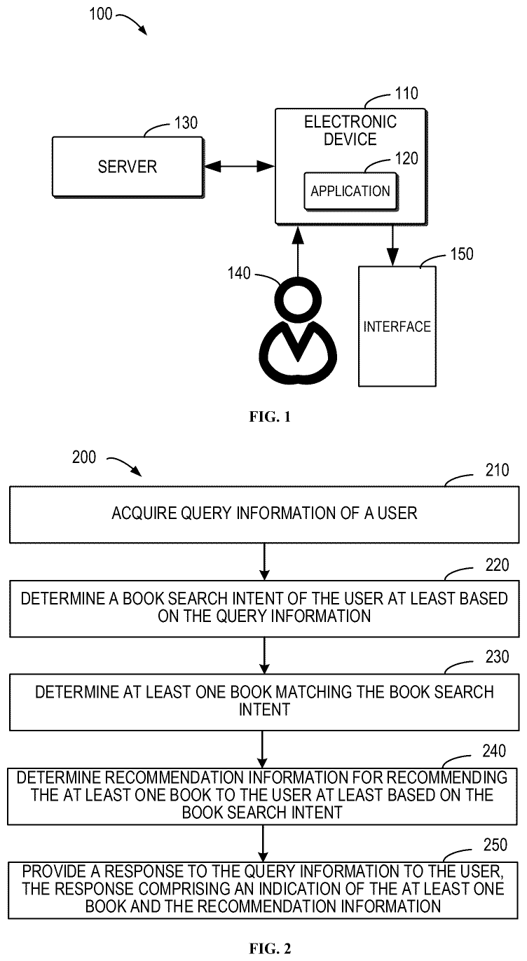

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, especially an application that can perform book search and book reading. Examples of the application 120 may include, but are not limited to: a novel application, a reading application, or other suitable applications. A user 140 may interact with the application 120 via the electronic device 110 and/or its attached device.

In the environment 100 in FIG. 1, if the application 120 is in an active state, the electronic device 110 may display an interface 150 for supporting the interface interaction through the application 120.

In some embodiments, the electronic device 110 communicates with a server 130 to enable provision of services for the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (Personal Communication System, PCS) device, a personal navigation device, a personal digital assistant (Personal Digital Assistant, PDA), an audio/video player, a digital camera/video camera, a positioning device, a television receiver, a radio broadcast receiver, an e-book device, a game device, or any combination thereof, including accessories and peripherals of these devices or any combination thereof. In some embodiments, the electronic device 110 can also support any type of interface for the user (such as a “wearable” circuit, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communication, middleware services, domain name services, security services, content delivery networks, and big data and artificial intelligence platforms. The server 130 may include, for example, a computing system/server, such as a mainframe, an edge computing node, a computing device in a cloud environment, and the like. The server 130 may provide background services for the application 120 in the electronic device 110 that supports virtual scenes.

A communication connection may be established between the server 130 and the electronic device 110. The communication connection may be established in a wired or wireless manner. The communication connection may include, but is not limited to, a Bluetooth connection, a mobile network connection, a universal serial bus (Universal Serial Bus, USB) connection, a wireless fidelity (Wireless Fidelity, Wi-Fi) connection, etc., and the embodiments of the present disclosure are not limited in this respect. In the embodiments of the present disclosure, the server 130 and the electronic device 110 may implement signaling interaction through the communication connection between them.

It should be understood that the structure and function of various elements in the environment 100 are described for illustrative purposes only, without implying any limitation to the scope of the present disclosure.

As briefly mentioned above, in the scenario where a user searches for a book, since each user has a different intent of searching for a book, it is difficult for a system to determine the real needs expressed by the user, thus reducing the accuracy of the book recommendation from the system to the user. Furthermore, in the case that the content of a novel is long, the cost of searching for the book is also increased, which results in the user giving up reading due to lack of understanding of the plot. Correspondingly, the posts about book search in the forum are also not answered.

According to an example implementation of the present disclosure, an improved solution for book search is proposed. The solution includes: first, acquiring query information of a user; then, determining a book search intent of the user at least based on the query information; subsequently, determining at least one book matching the book search intent based on the book search intent; correspondingly, determining recommendation information for recommending the at least one book to the user at least based on the book search intent; finally, providing a response to the query information to the user, the response including an indication of the at least one book and the recommendation information. Thereby, it is possible to quickly and accurately meet a user's personalized book search needs, and providing the recommendation information that better matches the intent can improve user satisfaction and conversion rate of book recommendation.

In a traditional book search scenario of a search engine, for any search query input by a user, the search engine always thinks that the user expects to find a specific book. Such an assumption may lead to limitations in search results and user interaction. However, in some embodiments of the present disclosure, by using a generative language model, intent understanding analysis may be performed based on the user input to determine whether the user expects to find a specific book, a category of books with certain features, or is performing a general chat, and then corresponding response may be provided to the user.

An example process according to embodiments of the present disclosure will be described below with reference to the drawings. It should be understood that the pages shown in the drawings are only examples, and various page designs may actually exist. Various graphic elements in a page may have different arrangements and different visual representations, one or more of the elements may be omitted or replaced, and one or more other elements may also exist. The embodiments of the present disclosure are not limited in this respect. In addition, in the following, example embodiments will be mainly described with respect to the electronic device 110.

A solution for book search of the present disclosure will be described below with reference to FIG. 2. FIG. 2 illustrates a flowchart of a process 200 for book search according to some embodiments of the present disclosure. The process 200 may be implemented at the electronic device 110. The process 200 will be described below with reference to FIG. 1. In some embodiments, the operations described with respect to the electronic device 110 may be performed at the application 120 and/or may be performed under the control/indication of a server-side device (e.g., the server 130) corresponding to the application 120.

At block 210, the electronic device 110 acquires query information of a user.

In some embodiments, the application 120 may provide a search engine, and the electronic device 110 may receive query information input by the user 140 in a search input box of the search engine.

In some embodiments, the application 120 may provide a digital assistant for having a dialogue with the user 140. The electronic device 110 may receive a chat message input by the user 140 in a dialogue window between the user 140 and the digital assistant as the query information.

In some embodiments, the application 120 may support a user to post, reply to the post, etc. The electronic device 110 may acquire post content input by the user 140 in the posted post of the user, the post content including a mention operation of the user 140 to the digital assistant (e.g., input “@” digital assistant). This means that the user 140 expects the digital assistant to reply to the post content, so that the post content can be acquired as the query information for subsequent processing. Alternatively, the electronic device 110 may acquire reply content input by the user 140 in a reply content (also referred to as “comment content”) to the post posted by the user, the reply content including a mention operation of the user 140 to the digital assistant (e.g., input “@”). This also means that the user 140 expects the digital assistant to continue to reply to the content, so that the reply content can be acquired as the query information for subsequent processing.

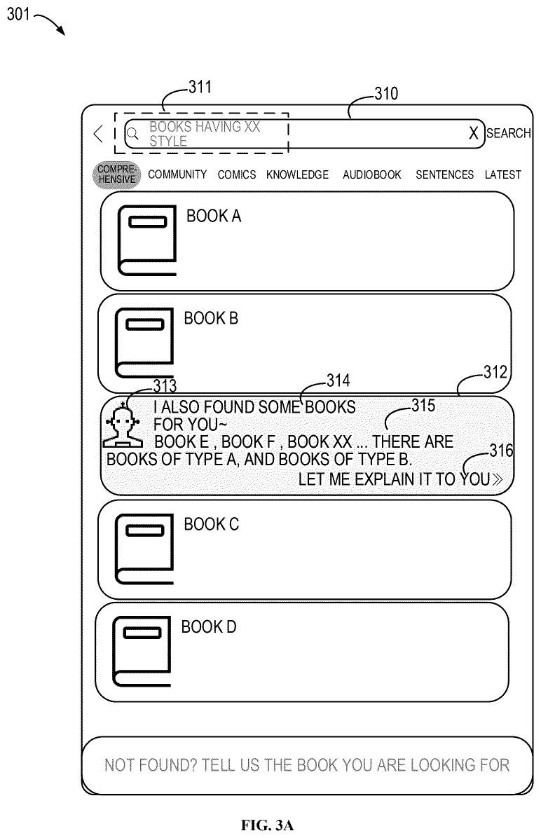

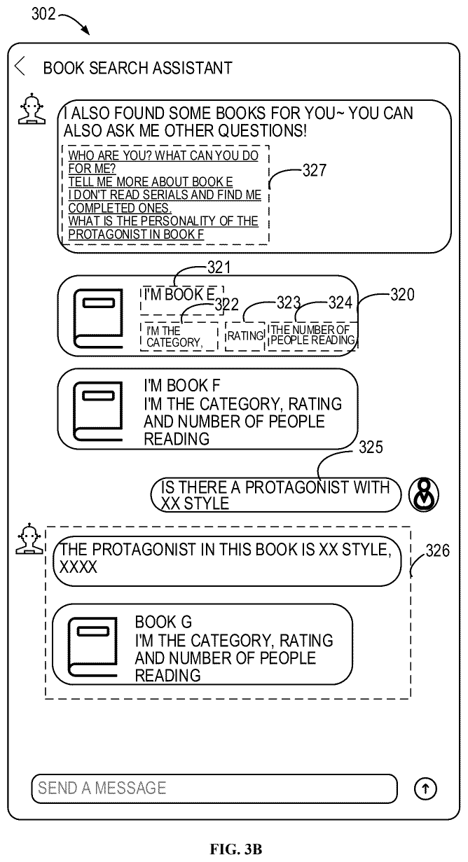

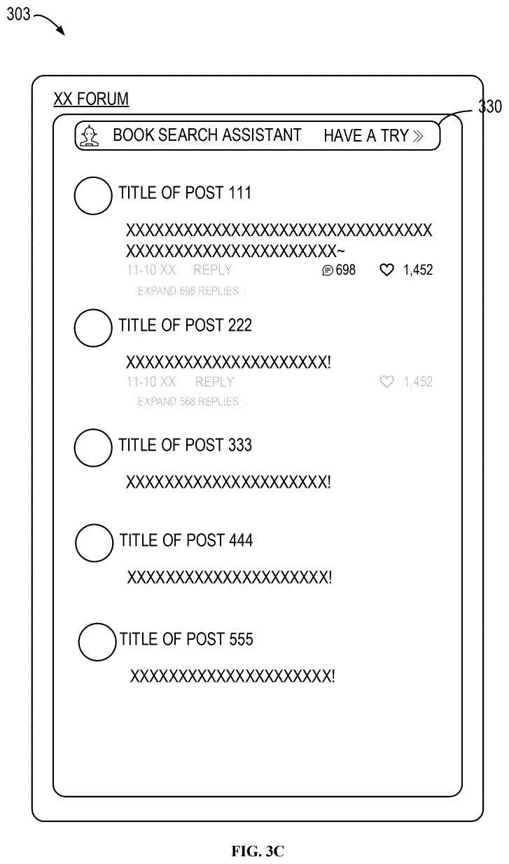

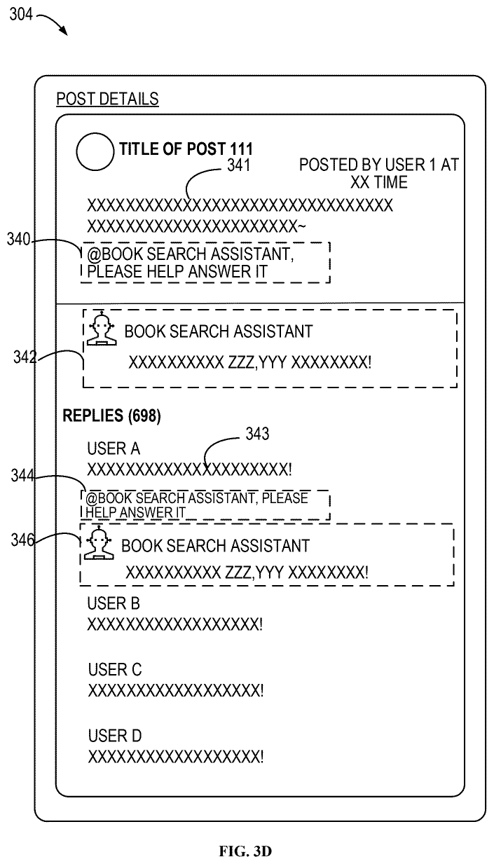

The following first describes the electronic device 110 receiving query information input by the user 140 in a search input box of a search engine with reference to FIG. 3A. Other embodiments about the electronic device 110 acquiring the query information of the user will be described in detail below. FIG. 3A illustrates a schematic diagram of an example interface 301 for book search according to some embodiments of the present disclosure.

In some embodiments, the electronic device 110 acquires search information input by a user in a search input box of a search engine. As shown in the example interface 301 in FIG. 3A, the electronic device 110 acquires search information 311 input by the user 140 in the search input box 310 of the search engine.

At block 220, the electronic device 110 determines a book search intent of the user at least based on the query information. After the user 140 inputs the query information and the electronic device 110 acquires the query information of the user 140, the electronic device 110 determines the book search intent of the user 140 at least based on the query information of the user 140.

For example, if the query information input by the user 140 is “books similar to Book A”, the electronic device 110 determines, based on the “books similar to Book A” input by the user 140, that the book search intent of the user 140 includes the writing style of Book A, the world view of Book A, and so on.

In some embodiments, the electronic device 110 may determine the book search intent of the user by a target model by providing the query information to the target model. In some examples, the electronic device 110 may determine, using the target model, whether the query information of the user includes a book search intent.

In some cases, in an interaction process with a user, especially in a dialogue between the user and the digital assistant, the message sent by the user may not necessarily be to perform a book search. With the help of the model, the message sent by the user can be better understood, and when the user needs to perform a book search, a matching book can be recommended to the user by accurately identifying a book search intent in the message.

In some examples, the electronic device 110 uses a generative language model (LM) to determine a book search intent in the query information of the user 140 that is acquired by the electronic device 110. For example, the electronic device 110 uses a generative large language model (LLM) to determine whether the query information of the user 140 that is acquired by the electronic device 110 includes a book search intent. The language model is a model pre-trained on the basis of a large corpus, and has the capability of accurately understanding the semantics of a model input, especially a text input. In addition, the language model can also generate a corresponding model response based on the model input. With the language model, a user intent in the query information from the user can be accurately determined. In some embodiments, the query information may be used as a model input, or a prompt input may be constructed based on the query information to be provided to the target model.

In some embodiments, the target model may run locally on the electronic device 110 or may run on a remote server-side. In the case of local running, the electronic device 110 may directly call the target model to perform intent recognition. In the case of running on a remote server-side, the electronic device 110 may send the query information or a prompt input constructed based on the query information to a server-side (e.g., the server 130), and the server-side calls the target model to perform intent recognition. The use of the target model described below may be implemented in any of the manners described herein. The embodiments of the present disclosure are not limited in this respect.

At block 230, the electronic device 110 determines at least one book matching the book search intent. In some examples, the electronic device 110 determines at least one book matching the book search intent after determining the book search intent of the user based on the query information.

For example, if the query information input by the user 140 is “books similar to Book A”, it is determined that the book search intent of the user 140 is “the writing style of Book A”. Then, the electronic device 110 determines, based on “the writing style of Book A”, at least one book matching “the writing style of Book A”.

For another example, the electronic device 110 determines, based on the query information “palace intrigue” input by the user 140, that the book search intent of the user 140 is “books containing palace intrigue”. Then, the electronic device 110 determines, based on “books containing palace intrigue”, at least one book matching “books containing palace intrigue”.

In some embodiments, a first book of the at least one book determined by the electronic device 110 has a plurality of content carriers. In some examples, the electronic device 110 determines the at least one book based on the search intent of the user 140, and each of the at least one book may have a plurality of carriers.

For example, the electronic device 110 determines the at least one book based on the search intent of the user 140, and each of the at least one book may have audio for listening, short drama, comics, and so on.

In some embodiments, the electronic device 110 determines, based on the book search intent, at least one content carrier for recommendation from the plurality of content carriers of the first book. The electronic device 110 determines, based on the search intent of the user, at least one content carrier for recommendation (e.g., a short drama corresponding to the first book, a comic corresponding to the first book) from a plurality of carriers corresponding to the first book (e.g., an audio corresponding to the first book, a short drama corresponding to the first book, a comic corresponding to the first book).

For example, the electronic device 110 may determine, based on the context of the interaction with the user 140, at least one content carrier that the user 140 needs, and recommend the at least one content carrier to the user 140.

In some embodiments, the electronic device 110 determines a recommended reading progress of the at least one book based on the book search intent and historical interaction of the user with the at least one book. In some examples, if the user 140 has previously interacted with the at least one book, the electronic device 110 may determine the recommended reading progress of the at least one book based on the search intent of the user 140 and the previous interaction with the at least one book.

For example, the electronic device 110 determines “Book XX” based on the search intent of the user 140. If the user 140 has read a part of “Book XX”, the electronic device 110 directly locates to the target chapter that the user 140 has read based on the search intent of the user 140 and the context of the book. The electronic device 110 may also recommend several chapters in the book to the user 140 based on the search intent of the user 140 and the context of the book, for the user to choose from.

In some embodiments, the electronic device 110, in response to determining the book search intent of the user, may further use the target model to determine at least one book for recommendation at least based on the book search intent.

In some examples, if the electronic device 110 determines that the query information input by the user 140 includes the book search intent, the electronic device 110 uses the target model to determine at least one book for recommendation at least based on the book search intent.

As shown in the example interface 301 in FIG. 3A, the user 140 inputs “books having XX style” in the search input box 310, and the electronic device 110 may determine that the information input by the user 140 includes a book search intent (e.g., to search for books in XX style). In this way, the electronic device 110 determines at least one book for recommendation, such as “Book E”, “Book F”, “Book XX”, etc., at least based on the book search intent. The electronic device 110 determining at least one book for recommendation based on the book search intent will be described in detail below.

At block 240, the electronic device 110 determines recommendation information for recommending the at least one book to the user at least based on the book search intent. The electronic device 110 determines the recommendation information of the at least one book recommended to the user 140 at least according to the determined book search intent. It can be understood that for the query information input by the user (e.g., “books similar to Book A” or “palace intrigue” input by the user), book search is performed. However, the recommendation information corresponding to the books provided by the electronic device to the user is different.

For example, for the “books similar to Book A” input by the user, the electronic device 110 determines that the books for recommendation are “Book B”, “Book C”, “Book D”, etc. The electronic device 110 presents the recommendation information of “Book B” as a book having the writing style of Book A, the recommendation information of “Book C” as a book having the world view of Book A, and the recommendation information of “Book D” as a book in which the character A in “Book D” has the writing style of Book A.

For another example, for the “books having XX plot” input by the user, the electronic device 110 determines that the books for recommendation are “Book X”, “Book XX”, “Book XXX”. The electronic device 110 presents the recommendation information of “Book X”, “Book XX” and “Book XXX” as having palace intrigue.

In some embodiments, the electronic device 110 determines the recommendation information based on the book search intent and information associated with the at least one book. The information associated with the at least one book includes content in the at least one book, user interaction information related to the at least one book, or historical interaction of the user with the at least one book.

In some examples, the electronic device 110 may determine the recommendation information based on the book search intent and information associated with the content in the at least one book. For example, the user 140 searches for “books belonging to the fantasy category”, and the electronic device 110 determines “Book XX about Time Traveling” based on the search intent. Then, the electronic device 110 determines, based on the search intent and the content of “Book XX about Time Traveling”, the recommendation information as: the genre of the book belongs to the fantasy category.

In some examples, the electronic device 110 may determine the recommendation information based on the book search intent and the user interaction information associated with the at least one book. For example, the user 140 searches for “rebirth story”, and the electronic device 110 determines “Book about Returning to Year X” based on the search intent. Then, the electronic device 110 determines, based on the search intent and the comments previously made on “Book about Returning to Year X”, the recommendation information as: you have commented on this book, and this book belongs to the rebirth story.

For another example, the user may have previously underlined a plot in a book belonging to the “rebirth story”, and the electronic device 110 determines, based on the user's underlining of the plot and the search intent, the recommendation information of “Book about Returning to Year X” as that the book contains a plot similar to the plot. In some embodiments, the user may click on the plot similar to the plot to read.

In some examples, the electronic device 110 may determine the recommendation information based on the book search intent and the historical interaction with the at least one book. For example, the user 140 searches for “WW style”, and the electronic device 110 determines “WW style” based on the search intent. Then, the electronic device 110 determines, based on the search intent and determining that the user has previously added the book to the bookshelf, favorited the book, etc., the recommendation information of the book as: you have previously added the book to the bookshelf, favorited the book, and the book belongs to the WW style.

At block 250, the electronic device 110 provides a response to the query information to the user. The response that the electronic device 110 provides to the user includes an indication of the at least one book and the recommendation information. In some examples, after determining the at least one book for recommendation, the electronic device 110 provides, to the user 140, the indication of the at least one book and the recommendation information for the query information. The provided response is presented in a user interface of the application 120.

In some embodiments, if the electronic device 110 acquires the search information that the user inputs in a search input box, the electronic device 110 may present the response to the query information provided to the user in the search result page along with the search results. The search results are determined by a search engine based on the search information, that is, search results determined by the search engine based on the search information (also referred to as a search keyword) of the user in the search input box.

As shown in the example interface 301 in FIG. 3A which illustrates a search result page, if the electronic device 110 acquires the search information 311 input by the user 140 in the search input box 310, the electronic device 110 presents, in the search result page, the response 312 to the search information that is determined using the target model and provided to the user, along with the search results. For example, the electronic device 110 may present, in the response 312, an avatar 313 of the digital assistant, a recommendation phrase 314, recommended books 315, a guidance text 316, etc. The response 312 may be presented in the search result page in the form of a floating window, a pop-up window, or any other suitable form.

The electronic device 110 may present the recommendation phrase 314 in the response 312, such as “I also found some books for you˜”, “Don't know which ones to choose? Let me introduce them to you”, “Do you need me to find books for you? I′m so good at it”, etc. Of course, these are only examples, and any other recommendation phrases may be designed, or no recommendation phrase may be provided.

The rule for the content 315 of the recommended book presented by the electronic device 110 in the response 312 is: the titles of the first three books, and the category (for example, “Book E, Book F, Book XX . . . . There are books of type A, and books of type B”). The specific rule is: if the three books belong to the same category, the electronic device 110 presents in the response 312 as “Book, Book, Book, all are books of type XXX (category name)”. If the three books belong to more than two categories, the electronic device 110 presents the first two categories in the response 312: “Book, Book, Book, there are books of type XXX (category name), and books of type XXX (category name)”. Of course, these are only examples, and the recommended books may also be indicated based on any other rules.

In some embodiments, the response to the query information that the electronic device 110 provides to the user includes an indication of the at least one book. In the case that a first book of the at least one book has a plurality of content carriers, the indication of the at least one book in the response that the electronic device 110 provides to the user includes an indication of at least one content carrier of the first book.

For example, the response to the query information that the electronic device 110 provides to the user includes an indication of “Book A”, an indication of “Book B”, an indication of “Book C”, and so on. If “Book A” has content carriers such as audio, comics, etc., the response that the electronic device 110 provides to the user includes an indication of the audio of “Book A” and an indication of the corresponding comic of “Book A”.

In some embodiments, the response to the query information that the electronic device 110 provides to the user includes an indication of the at least one book. In the case that a part of the at least one book has been read by the user, the indication of the at least one book in the response that the electronic device 110 provides to the user includes a positional indication of a recommended reading progress of the at least one book. In this way, the user may directly start to read a plot from the corresponding reading progress through the provided positional indication.

For example, the response to the query information that the electronic device 110 provides to the user includes an indication of “Book A”, an indication of “Book B”, an indication of “Book C”, and so on. If “Book B” has been read by the user to a certain plot, the response that the electronic device 110 provides to the user includes a positional indication of the certain plot in “Book B” that has been read by the user. Alternatively, the response that the electronic device 110 provides to the user may also include positional indications of several plots in “Book B”. In this way, the user can directly and quickly see the plots that he/she wants to read through the provided positional indications.

In some embodiments, in the search result page, the response that the electronic device 110 provides to the user further includes an entry for triggering a chat window between the user and a digital assistant for book search. If the user expects to jump from a search engine to a chat window with the digital assistant, it can be achieved by triggering the entry. In some examples, the electronic device 110 presents, in the response 312, a guidance text 316, such as “Let me explain it to you”, “Help me choose which one”, “Recommend it to me”, etc. The guidance text 316 may guide the user to trigger the chat window of the digital assistant.

In some examples, the electronic device 110 determining at least one book for recommendation based on the book search intent refers to all books that match the query information of the user 140 determined by the electronic device 110. However, for visual simplicity, when the electronic device 110 presents on a page, it first presents some of the books that match the query information. As shown in the example interface 301 in FIG. 3A, if the user 140 clicks on the guidance text 316, the electronic device 110 will present all the books for the user 140 to view all the books.

In some embodiments, the response that the electronic device 110 provides to the user includes recommendation information of one or more books. The recommendation information includes at least an indication of the book to be recommended, for example, a book card. As shown in the schematic diagram 302 in FIG. 3B, the recommendation information includes at least an indication 320 (e.g., a book card) of the book to be recommended, including a book name 321 (e.g., “I′m Book E”), an access entry of the book (e.g., the detailed information of the book can be viewed by clicking on the book name 321), the number of people reading 320, a rating 323, comments, and additional information, where the additional information may be determined based on the book content and/or the query information, etc. Examples of such information will be referred to in more detail in the description of FIG. 3B below.

The above describes that the electronic device 110 provides a response to the query information to the user 140 according to the query information containing the book search intent. The following will continue to describe that the electronic device 110 determines whether the query information contains the book search intent.

In some embodiments, in the case of acquiring the query information input by the user from the search input box, the electronic device 110 may further determine, based on the search keyword in the input box, whether to use the target model to further analyze the search keyword. If it is determined that the target model is to be used to analyze the search keyword, the electronic device 110 will use the target model to determine whether the search keyword contains the book search intent, and then a search result page as shown in FIG. 3A may be provided, which contains a response 312 for book recommendation determined using the target model.

In some examples, the electronic device 110 determines whether the search keyword input by the user 140 satisfies a predetermined condition, and in the case that the predetermined condition is satisfied, the target model will be called to generate a digital assistant (e.g., a robot) response, and the response is presented in the search result page. On the contrary, if the predetermined condition is not satisfied, only the search results determined by the search engine are presented in the search result page, and the response for book recommendation determined using the target model is not presented.

In some embodiments, the electronic device 110 determines a search result click-through rate (sometimes referred to as “click-to-view ratio”) corresponding to the search keyword, whether the search keyword corresponds to a fuzzy book search, and/or a character length of the search key word. The fuzzy book search indicates that the search keyword is a keyword that does not match a specific book or a specific book type. For example, if the search keyword does not accurately hit the author, the book, and the title of each genre, the name of the protagonist, etc., such a search keyword may be considered to correspond to the fuzzy book search.

In some embodiments, if the search result click-through rate is below a click-through rate threshold, the electronic device 110 may determine that the target model is to be used to further analyze the search keyword in the search input box. For example, the search result click-through rate (sometimes referred to as “click-to-view ratio”): the ratio between the number of people who click on the search results and the total number of people who initiate the search using the query after the search is initiated using a search term. The higher the “click-to-view ratio”, the greater the possibility that the user's search intent will be satisfied after searching with the search term. For example, if the “click-to-view ratio” of a certain search term is 100%, it means that the user who queries with this search term will surely find the e-book he/she wants to query. If the “click-to-view ratio” is relatively low, then the user may probably not be able to find the desired book through the current search term, that is, the search result is not an accurate hit. In some embodiments, if it is determined that the “click-to-view ratio” corresponding to the search keyword input by the user is below a predetermined threshold, it may be determined that the target model is to be used to analyze the search keyword, and a response determined by the target model is provided in the search result page.

In some embodiments, if the search keyword corresponds to the fuzzy book search, the electronic device 110 may determine that the target model is to be used to further analyze the search keyword in the search input box. For example, the search keyword is information that does not accurately hit the author/book and the title/name of the protagonist of each genre, and the electronic device 110 determines to use the target model to analyze the search keyword.

In some embodiments, if the character length of the search keyword exceeds a length threshold, the electronic device 110 may determine that the target model is to be used to further analyze the search keyword in the search input box. For example, if the number of characters of the search keyword is greater than or equal to 6, the electronic device 110 determines to use the target model to analyze the search keyword.

The above describes that the electronic device 110 determines the book search intent based on the search keyword. The following will continue to describe the case where the query information does not contain the book search intent. In some embodiments, the electronic device 110, in response to determining that the query information does not contain the book search intent, uses the target model to determine another response to the query information. Correspondingly, the electronic device 110 provides another response to the user.

In some examples, if it is determined that the query information does not contain the book search intent, the electronic device 110 calls a general knowledge base through the target model to interact with the user 140. For example, the user 140 inputs the information “Who are you?”, and the electronic device 110 determines that the query information does not contain the book search intent, the electronic device 110 calls the general knowledge base through the target model to interact with the user 140. For another example, the user 140 inputs the information “Do you like reading?”, then, the electronic device 110 determines, by using the target model to understand this information, whether it contains the book search intent. If it does not, the electronic device 110 may call other plug-ins to answer.

In the embodiments of the present disclosure, based on the query information input by the user (e.g., a long text for book query), the electronic device 110 uses the target model to understand the user intent, and converts the query information into several tags. Then, the query information is understood based the identifier (tag) and the target model, and then the book matching the query information is determined.

Other embodiments about the electronic device 110 acquiring the query information of the user will be described below with reference to FIG. 3B to FIG. 3C. FIG. 3B to FIG. 3C illustrate schematic diagrams of example interfaces 302 to 303 for acquiring the query information of the user according to some embodiments of the present disclosure.

In some embodiments, the electronic device 110 acquires a chat message input by the user in a chat window in response to the chat window between the user and a digital assistant for book search being triggered. The digital assistant for book search is referred to as a “book search assistant” in the examples of the drawings. In some examples, if the chat window between the user 140 and the digital assistant for book search is triggered, the electronic device 110 may present the chat window 302 between the user and the digital assistant.

In some embodiments, the chat window 302 between the user 140 and the digital assistant for book search may be entered by clicking on a pop-up window of the digital assistant presented in a search page. For example, the user 140 clicks on the guidance text 316, and the electronic device 110 presents the chat window 302 between the user 140 and the digital assistant for book search.

In some embodiments, an access entry of the digital assistant may be provided in a forum for posting a topic post or in any suitable page of a book reading application. As shown in the example interface 303 in FIG. 3C, the user 140 may click on an access entry 330 corresponding to the “book search assistant” presented by the electronic device 110. The electronic device 110 may present the chat window 302 between the user and the digital assistant for book search based on a trigger operation of the user 140 on the access entry 330.

The electronic device 110 presents all the books matching the query information of the user 140 in the chat window 302 based on the user 140 clicking on the guidance text 316. In some examples, the electronic device 110 may also present some of the books matching the query information of the user 140 in the chat window 302 based on the user 140 clicking on the guidance text 316. Then, all the books are presented by the electronic device 110 in the chat window 302 based on the user 140 clicking on a “view all” control.

In some embodiments, the electronic device 110 acquires a chat message input by the user in the chat window in response to the chat window being triggered. Subsequently, the electronic device 110 presents, in the chat window, the response as a reply message to the chat message.

As shown in the example interface 302 in FIG. 3B, the electronic device 110 acquires a chat message 325 input by the user 140 in the chat window 302. Then, the electronic device 110 presents, in the chat window 302, a reply message 326 to the chat message 325 as the response.

In some examples, the electronic device 110 further presents a prompt 327 in the chat window 302. For example, prompts such as “Who are you? What can you do for me?”, “Tell me more about Book E”, “I don't read serials, find me completed ones”, etc. If the user 140 clicks on the prompt 327, the electronic device 110 will default that the user 140 initiates a chat message. The electronic device 110 further presents evaluation feedback in the chat window 302, such as a positive evaluation, a negative evaluation, etc.

The above describes the embodiments of the electronic device 110 acquiring the query information of the user with reference to FIG. 3B to FIG. 3C. Another embodiment for acquiring the query information of the user will be described below with reference to FIG. 3D. FIG. 3D illustrates a schematic diagram of an example interface 304 for acquiring the query information of the user according to other embodiments of the present disclosure.

In some embodiments, the electronic device 110 acquires post content posted by a user or reply content to the post content, and the digital assistant is mentioned in the post content or the reply content. Then, the electronic device 110 presents the response to the query information provided to the user as reply content to the post content or further reply content to the reply content.

As shown in the example interface 304 in FIG. 3D, the user 140 (e.g., user 1) may mention (e.g., “@”) the book search assistant for the post content 341 posted by him/her. For example, mention the book search assistant information 340 as “@book search assistant, please help answer it”. Then, the electronic device 110 uses the post content 341 as the query information of the user 1, and presents further reply content 342 to the post information.

The user A may also reply to the post content posted by the user 1. In some examples, if the electronic device 110 receives the reply content 343 of the user A to the post content posted by the user 1, and receives that the user A mentions (e.g., “@”) the book search assistant for the reply content 343. For example, mention the book search assistant information 344 as “@book search assistant, please help answer it”. Then, the electronic device 110 uses the reply content 343 of the post content as the query information of the user A, and presents further reply content 346 to the reply content of the post content.

For example, the user 140 may @ the digital assistant in a posted post, or may @ the digital assistant in a reply to the post. In either case, the content corresponding to @ the digital assistant is acquired as the query information of the user 140.

Some other embodiments about the electronic device 110 acquiring the query information of the user are described above. The following will continue to describe the electronic device 110 determining at least one book for recommendation based on a current book search intent.

In some embodiments, the electronic device 110 obtains at least one historical book search intent identified in historical interaction information of the user. Correspondingly, the electronic device 110 determines an actual book search intent of the user based on the current book search intent and the at least one historical book search intent, and then determines at least one book for recommendation based on the actual book search intent. In some embodiments, the electronic device 110 identifies at least one historical book search intent from multiple rounds of interactions that may be performed between the user 140 and the digital assistant. In some embodiments, the multiple rounds of interactions between the user 140 and the digital assistant may include multiple rounds of chat messages between the user and the digital assistant in a chat window. In some embodiments, the multiple rounds of interactions between the user 140 and the digital assistant may include multiple rounds of comments and replies between the user 140 and the digital assistant in a certain post. In addition to the at least one round of historical interaction between the user and the digital assistant, the historical book search intent of the user may also be determined from the historical search keywords of the user in the search input box, the historical post content of the user in the forum, etc.

For example, the search intent of the user 140 in the first round of interaction with the digital assistant is to find a book of ancient style. At this time, the electronic device 110 searches for the book of ancient style based on the book search intent. Then, the search intent of the user 140 in the second round of interaction with the digital assistant is not to have books of the Tang Dynasty, but to find books of the Song Dynasty. At this time, the electronic device 110 supplements the second round of interaction with the first round of interaction. That is, the electronic device 110 determines the final at least one book for recommendation based on the search intent corresponding to “finding a book of ancient style” and the search intent corresponding to “not having books of the Tang Dynasty, but finding books of the Song Dynasty”.

Therefore, in the present disclosure, by linking the book search intents of the user in each of at least one round of interaction in the at least one round of interaction, the user does not need to completely input his/her book request every time. Then, the electronic device 110 determines at least one book for recommendation based on the book search intent of the user in each round.

For example, in the first round of interaction between the user and the digital assistant, the query information input by the user is “a certain type of book”. The electronic device 110 determines the query intent based on the query information, and determines 10 candidate books. Subsequently, the user may continue to input the query information “I don't want type A” to initiate the second round of interaction between the user and the digital assistant. The electronic device 110 determines the query intent based on “I don't want type A” and “a certain type of book”, and determines 5 candidate books. At this time, the user may also continue to input the query information “I like type B” to initiate the third round of interaction between the user and the digital assistant. The electronic device 110 determines the query intent based on “I like type B”, “I don't want type A” and “a certain type of book”, and determines 3 candidate books. Then, the user may also input the query information “Can you pick out the best one for me?” based on the 3 candidate books to initiate the fourth round of interaction between the user and the digital assistant. The electronic device 110 makes suggestions according to the number of advantages and disadvantages of the 3 candidate books. For example, suggestion 1: “If you like a certain style, you can choose the first one”. Suggestion 2: “If you care about a certain style, you can choose the second one”. Suggestion 3: “Then if you just want to avoid a certain style, you can choose the third one”.

In some embodiments, the electronic device 110 determines a degree of association between the at least one historical book search intent and the book search intent. Subsequently, if the electronic device 110 determines that the degree of association between one or more of the at least one historical book search intent and the book search intent exceeds an association threshold, the electronic device 110 determines the at least one book for recommendation based on the book search intent and the one or more historical book search intents.

In some examples, the electronic device 110 determines a degree of association between the at least one historical book search intent and the book search intent. The electronic device 110 determines the current book to be recommended based on the historical book search intent with a high degree of association with the book search intent.

In some examples, if the book search intents in two rounds of interactions between the user and the digital assistant have a low degree of association, the electronic device 110 will not determine the current book to be recommended according to the context. For example, the user inputs query information in the first round of interaction yesterday, and then initiates again today, the electronic device 110 will not determine the current book to be recommended according to the context.

For another example, the semantics of the query information input by the user in the two consecutive rounds of interactions are contradictory (for example, the query information input in the first round is “I want to find a novel for male”, and the query information input in the second round is “I want to find a novel for female”). Since the book search intents in the two consecutive rounds of interactions of the user have a great difference in directivity, the electronic device 110 will not determine the current book to be recommended according to the context.

In the present disclosure, the search intent in multiple rounds of interactions between the user and the digital assistant may be continuously supplemented to search for keywords in detail. By understanding the search intent of the user and making the search after the directivity of the user is determined, the user may be answered independently, thereby improving the matching rate with the user's search intent.

In summary, by using a generative language model, intent understanding analysis may be performed based on the user input, and it is determined that the user expects to find a specific book, a category of books with certain features, or is performing a general dialog, so that corresponding response may be provided to the user. Furthermore, through this method, the conversion rate of book recommendation and the user retention are improved.

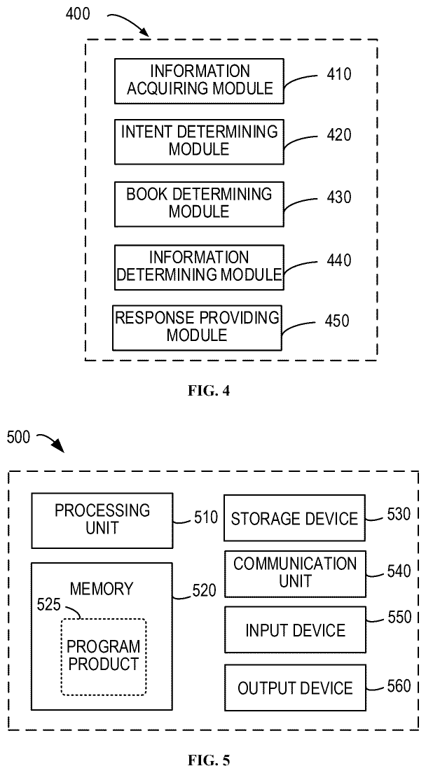

The embodiments of the present disclosure also provide corresponding apparatuses for implementing the above methods or processes. FIG. 4 illustrates a block diagram of an apparatus 400 for book search according to some embodiments of the present disclosure. The apparatus 400 may be implemented or included in the electronic device 110 in FIG. 1. Modules/components in the apparatus 400 may be implemented by hardware, software, firmware, or any combination thereof.

As shown in the figure, the apparatus 400 includes: an information acquiring module 410 configured to acquire query information of a user. The apparatus 400 further includes an intent determining module 420 configured to determine a book search intent of the user at least based on the query information. The apparatus 400 further includes a book determining module 430 configured to determine at least one book matching the book search intent.

The apparatus 400 further includes an information determining module 440 configured to determine recommendation information for recommending the at least one book to the user at least based on the book search intent. The apparatus 400 further includes a response providing module 450 configured to provide a response to the query information to the user, the response including an indication of the at least one book and the recommendation information.

In some embodiments, at least based on the book search intent, the information determining module 440 is further configured to determine the recommendation information based on the book search intent and information associated with the at least one book, where the information associated with the at least one book includes at least one of: content in the at least one book, user interaction information related to the at least one book, or historical interaction of the user with the at least one book.

In some embodiments, a first book of the at least one book has a plurality of content carriers, and the apparatus 400 further includes a carrier determining module configured to determine, based on the book search intent, at least one content carrier for recommendation from the plurality of content carriers of the first book, and where the indication of the at least one book in the response includes an indication of the at least one content carrier of the first book.

In some embodiments, the information acquiring module 410 is further configured to acquire a chat message input by the user in the chat window in response to the chat window between the user and the digital assistant for book search being triggered; and where providing the response to the query information to the user includes: presenting the response, in the chat window, as a reply message to the chat message.

In some embodiments, the information acquiring module 410 is further configured to acquire post content posted by the user or reply content to the post content, the digital assistant being mentioned in the post content or the reply content; and where providing the response to the query information to the user includes: presenting the response as reply content to the post content or further reply content to the reply content.

In some embodiments, the information acquiring module 410 is further configured to acquire a search keyword input by the user in a search input box of a search engine, and where providing the response to the query information to the user includes: presenting the response in a search result page along with search results, the search results being determined by the search engine based on the search keyword.

In some embodiments, in the search result page, the response further includes an entry for triggering a chat window between the user and the digital assistant for book search.

In some embodiments, the apparatus 400 further includes an information determining module configured to determine a search result click-through rate corresponding to the search keyword, whether the search keyword corresponds to a fuzzy book search, or a character length of the search keyword, the fuzzy book search indicating that the search keyword is a keyword that does not match a specific book or a specific book type; and determine to present the response in the search result page along with the search results based on at least one of: the search result click-through rate being below a click-through rate threshold, the search keyword corresponding to the fuzzy book search, or the character length of the search keyword exceeding a length threshold.

In some embodiments, the intent determining module 420 is further configured to determine the book search intent of the user by a target model by providing the query information to the target model.

In some embodiments, the book determining module 430 is further configured to determine the at least one book using the target model, based on the book search intent.

In some embodiments, the intent determining module 420 is further configured to determine the book search intent of the user based on the query information and historical interaction information in at least one round of historical interaction with the user.

In some embodiments, based on the query information and the historical interaction information in the at least one round of historical interaction with the user, the intent determining module 420 is further configured to identify a current book search intent from the query information; identify at least one historical book search intent from the historical interaction information; and determine the book search intent of the user based on the current book search intent and the at least one historical book search intent.

In some embodiments, based on the current book search intent and the at least one historical book search intent, the intent determining module 420 is further configured to determine a degree of association between the at least one historical book search intent and the current book search intent; and in response to determining that the degree of association between one or more of the at least one historical book search intent and the current book search intent exceeds an association threshold, determine the book search intent of the user based on the current book search intent and the one or more of the at least one historical book search intent.

Units and/or modules included in the apparatus 100 may be implemented in various ways, including software, hardware, firmware, or any combination thereof. In some embodiments, one or more units and/or modules may be implemented using software and/or firmware, such as machine-executable instructions stored on a storage medium. In addition to or as an alternative to the machine-executable instructions, some or all of the units and/or modules in the apparatus 400 may be implemented at least in part by one or more hardware logic components. As an example rather than a limitation, example types of hardware logic components that may be used include a field programmable gate array (FPGA), an application specific integrated circuit (ASIC), an application specific standard product (ASSP), a system on chip (SOC), a complex programmable logic device (CPLD), etc.

FIG. 5 illustrates a block diagram of an electronic device 500 in which one or more embodiments of the present disclosure can be implemented. It should be understood that the electronic device 500 shown in FIG. 5 is only an example and should not constitute any limitation to the functions and scope of the implementations described herein. The electronic device 500 shown in FIG. 5 may be used to implement the electronic device 110 in FIG. 1 or the apparatus 400 shown in FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and can perform various processes according to programs stored in the memory 520. In a multi-processor system, multiple processing units execute computer-executable instructions in parallel to improve the parallel processing capability of the electronic device 500.

The electronic device 500 generally includes multiple computer storage media. Such media may be any available media accessible by the electronic device 500, including but not limited to volatile and non-volatile media, removable and non-removable media. The memory 520 may be volatile memory (for example, a register, a cache, a random-access memory (RAM)), non-volatile memory (for example, a read only memory (ROM), an electrically erasable programmable read only memory (EEPROM), a flash memory), or some combination thereof. The storage device 530 may be a removable or non-removable medium, and may include a machine-readable medium, such as a flash drive, a disk, or any other medium, which may be capable of storing information and/or data (for example, training data for training) and may be accessed within the electronic device 500.

The electronic device 500 may further include additional removable/non-removable, volatile/non-volatile storage media. Although not shown in FIG. 5, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data medium interfaces. The memory 520 may include a computer program product 525 having one or more program modules configured to perform various methods or acts of various implementations of the present disclosure.

The communication unit 540 enables communication with other electronic devices through a communication medium. Additionally, the functions of the components of the electronic device 500 may be implemented in a single computing cluster or multiple computing machines that can communicate through communication connections. Therefore, the electronic device 500 can operate in a networked environment using logical connections with one or more other servers, network personal computers (PCs), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) such as storage devices, display devices, etc., with one or more devices that enable the user to interact with the electronic device 500, or with any device (e.g., a network card, a modem, etc.) that enables the electronic device 500 to communicate with one or more other electronic devices through the communication unit 540 as required. Such communication may be performed via an input/output (I/O) interface (not shown).

According to an example implementation of the present disclosure, a computer-readable storage medium having computer-executable instructions stored thereon is provided, where the computer-executable instructions are executed by a processor to implement the method described above. According to an example implementation of the present disclosure, a computer program product is further provided, the computer program product is tangibly stored in a non-transitory computer-readable medium and includes computer-executable instructions, and the computer-executable instructions are executed by a processor to implement the method described above. According to an example implementation of the present disclosure, a computer program product having a computer program stored thereon is provided, and the program, when executed by a processor, implements the method described above.

Various aspects of the present disclosure are described herein with reference to the flowcharts and/or block diagrams of the method, apparatus, device and computer program product implemented in accordance with the present disclosure. It should be understood that each block of the flowcharts and/or block diagrams and the combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus, thereby producing a machine, such that the instructions, when executed by the processing unit of the computer or other programmable data processing apparatus, cause the apparatus to implement the functions/acts specified in one or more blocks in the flowcharts and/or block diagrams. These computer-readable program instructions may also be stored in a computer-readable storage medium, and these instructions cause the computer, programmable data processing apparatus and/or other devices to work in a specific way, so that the computer-readable medium having instructions stored thereon includes an article of manufacture, which includes instructions for implementing various aspects of the functions/acts specified in one or more blocks in the flowcharts and/or block diagrams.

The computer-readable program instructions may be loaded onto a computer, other programmable data processing apparatus, or other device, such that a series of operational steps are performed on the computer, other programmable data processing apparatus, or other device to produce a computer-implemented process, such that the instructions which, when executed on the computer, other programmable data processing apparatus, or other device, implement the functions/acts specified in one or more blocks in the flowcharts and/or block diagrams.

The flowcharts and block diagrams in the drawings show the architecture, functionality, and operation of possible implementations of systems, methods and computer program products according to multiple implementations of the present disclosure. In this regard, each block in the flowcharts or block diagrams may represent a module, a program segment, or a portion of instructions, which includes one or more executable instructions for implementing a specified logical function. In some alternative implementations, the functions noted in the blocks may also occur out of the order noted in the drawings. For example, two consecutive blocks may, in fact, be executed substantially concurrently, or the blocks may sometimes be executed in a reverse order, depending upon the functionality involved. It is also noted that each block of the block diagrams and/or flowcharts, and combinations of blocks in the block diagrams and/or flowcharts, may be implemented by a dedicated hardware-based system that performs the specified functions or acts, or may be implemented by a combination of dedicated hardware and computer instructions.

Various implementations of the present disclosure have been described above, and the above description is illustrative, not exhaustive, and is not limited to the disclosed implementations. Many modifications and changes will be apparent to those of ordinary skill in the art without departing from the scope and spirit of the described implementations. The selection of terms used herein is intended to best explain the principles, the practical application, or the improvement of the technology in the market of the implementations, or to enable other ordinary skilled in the art to understand the various implementations disclosed herein.

What is claimed is:

1. A method for book search, comprising:
acquiring query information of a user;
determining a book search intent of the user at least based on the query information;
determining at least one book matching the book search intent;
determining recommendation information for recommending the at least one book to the user at least based on the book search intent; and
providing a response to the query information to the user, the response comprising an indication of the at least one book and the recommendation information.

2. The method of claim 1, wherein determining the recommendation information for recommending the at least one book to the user at least based on the book search intent comprises:
determining the recommendation information based on the book search intent and information associated with the at least one book,
wherein the information associated with the at least one book comprises at least one of:
content in the at least one book,
user interaction information related to the at least one book, or
historical interaction of the user with the at least one book.

3. The method of claim 1, wherein a first book of the at least one book has a plurality of content carriers, and the method further comprises:
determining, based on the book search intent, at least one content carrier for recommendation from the plurality of content carriers of the first book, and
wherein the indication of the at least one book in the response comprises an indication of the at least one content carrier of the first book.

4. The method of claim 1, further comprising:
determining a recommended reading progress of the at least one book based on the book search intent and historical interaction of the user with the at least one book, and
wherein the indication of the at least one book in the response comprises a positional indication of the recommended reading progress of the at least one book.

5. The method of claim 1, wherein acquiring the query information of the user comprises:
in response to a chat window between the user and a digital assistant for book search being triggered, acquiring a chat message input by the user in the chat window, and
wherein providing the response to the query information to the user comprises:
presenting the response, in the chat window, as a reply message to the chat message.

6. The method of claim 1, wherein acquiring the query information of the user comprises:
acquiring post content posted by the user or reply content to the post content, the digital assistant being mentioned in the post content and the reply content, and
wherein providing the response to the query information to the user comprises:
presenting the response as reply content to the post content or further reply content to the reply content.

7. The method of claim 1, wherein acquiring the query information of the user comprises:
acquiring a search keyword input by the user in a search input box of a search engine, and
wherein providing the response to the query information to the user comprises:
presenting the response in a search result page along with search results, the search results being determined by the search engine based on the search keyword.

8. The method of claim 7, wherein in the search result page, the response further comprises an entry for triggering a chat window between the user and a digital assistant for book search.

9. The method of claim 7, further comprising:
determining a search result click-through rate corresponding to the search keyword, whether the search keyword corresponds to a fuzzy book search, or a character length of the search keyword, the fuzzy book search indicating that the search keyword is not matched with a keyword of a specific book or a specific book type; and
determining to present the response in the search result page along with the search results based on at least one of:
the search result click-through rate being below a click-through rate threshold,
the search keyword corresponding to the fuzzy book search, or
the character length of the search keyword exceeding a length threshold.

10. The method of claim 1, wherein determining the book search intent of the user at least based on the query information comprises:
determining the book search intent of the user by a target model by providing the query information to the target model.

11. The method of claim 10, wherein determining the at least one book matching the book search intent comprises:
determining the at least one book using the target model, based on the book search intent.

12. The method of claim 1, wherein determining the book search intent of the user at least based on the query information comprises:
determining the book search intent of the user based on the query information and historical interaction information in at least one round of historical interaction with the user.

13. The method of claim 12, wherein determining the book search intent of the user based on the query information and the historical interaction information in the at least one round of historical interaction with the user comprises:
identifying a current book search intent from the query information;
identifying at least one historical book search intent from the historical interaction information; and
determining the book search intent of the user based on the current book search intent and the at least one historical book search intent.

14. The method of claim 13, wherein determining the book search intent of the user based on the current book search intent and the at least one historical book search intent comprises:
determining a degree of association between the at least one historical book search intent and the current book search intent; and
in response to determining that the degree of association between one or more of the at least one historical book search intent and the current book search intent exceeds an association threshold, determining the book search intent of the user based on the current book search intent and the one or more of the at least one historical book search intent.

15. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
acquiring query information of a user;
determining a book search intent of the user at least based on the query information;
determining at least one book matching the book search intent;
determining recommendation information for recommending the at least one book to the user at least based on the book search intent; and
providing a response to the query information to the user, the response comprising an indication of the at least one book and the recommendation information.

16. The electronic device of claim 15, wherein determining the recommendation information for recommending the at least one book to the user at least based on the book search intent comprises:
determining the recommendation information based on the book search intent and information associated with the at least one book,
wherein the information associated with the at least one book comprises at least one of:
content in the at least one book,
user interaction information related to the at least one book, or
historical interaction of the user with the at least one book.

17. The electronic device of claim 15, wherein a first book of the at least one book has a plurality of content carriers, and the acts further comprise:
determining, based on the book search intent, at least one content carrier for recommendation from the plurality of content carriers of the first book, and
wherein the indication of the at least one book in the response comprises an indication of the at least one content carrier of the first book.

18. The electronic device of claim 15, wherein the acts further comprise:
determining a recommended reading progress of the at least one book based on the book search intent and historical interaction of the user with the at least one book, and
wherein the indication of the at least one book in the response comprises a positional indication of the recommended reading progress of the at least one book.

19. The electronic device of claim 15, wherein acquiring the query information of the user comprises:
in response to a chat window between the user and a digital assistant for book search being triggered, acquiring a chat message input by the user in the chat window, and
wherein providing the response to the query information to the user comprises:
presenting the response, in the chat window, as a reply message to the chat message.

20. A non-transitory computer-readable storage medium having a computer program stored thereon, the computer program, when executed by a processor, causing the processor to implement acts comprising:
acquiring query information of a user;
determining a book search intent of the user at least based on the query information;
determining at least one book matching the book search intent;
determining recommendation information for recommending the at least one book to the user at least based on the book search intent; and
providing a response to the query information to the user, the response comprising an indication of the at least one book and the recommendation information.
